(19) United States
(12) Patent Application Publication
(10) Pub. No.: US 2025/0119643 A1
(43) Pub. Date: Apr. 10, 2025

(54) Method for Generating a Plurality of Focal Points for Different Positions

(71) Applicant: Leica Microsystems CMS GmbH, Wetzlar (DE)

(72) Inventors: Markus SCHECHTER, Wetzlar (DE); Oliver SCHLICKER, Wetzlar (DE)

(21) Appl. No.: 18/907,684

(22) Filed: Oct. 7, 2024

(30) Foreign Application Priority Data
Oct. 6, 2023 (DE) 102023127302.7

(51) Int. Cl. H04N 23/67

(52) U.S. Cl. CPC H04N 23/67

(57) ABSTRACT

The first aspect of this disclosure is related to a computer-based method for measurement of a plurality of optical foci, comprising the steps: measuring a first focus; obtaining one or both of: a) a focus range for a measurement of a second focus, wherein the focus range is based on the first focus; b) a starting value for a measurement of a second focus, wherein the starting value is based on the first focus; measuring the second focus with the obtained focus range and/or staring value; discarding the second focus, if the second focus is measured as an extreme value of the focus range; measuring a third focus.

### CROSS-REFERENCE TO RELATED APPLICATION

This application claims priority to German Application 102023127302.7, which was filed on Oct. 6, 2023. The content of this earlier filed application is incorporated by reference herein in its entirety.

### TECHNICAL FIELD

This disclosure is related to computer-based methods for measuring a plurality of optical foci. Furthermore medical devices are disclosed that are configured to measure a plurality of optical foci.

### BACKGROUND

An autofocus, for example in a microscope, is a function that allows the focus of an objective lens to be adjusted automatically to ensure clear and sharp images.

In case images are to be acquired at multiple positions or for larger regions, respective focus levels can differ between the locations. The location-dependent focus levels can be identified and stored in a focus map prior to image acquisition. However, an adjustment of a proper focus can be difficult. For example stains in sample holder, or holes in a specimen can lead to a wrong focal adjustment or to no identifiable focus at all. Therefore, improvements are desirable.

### SUMMARY

An object of the present disclosure is improvement of on autofocus system.

This object is solved by the disclosed embodiments, which are defined in particular by the subject matter of the independent claims. The dependent claims provide information for further embodiments. Various aspects and embodiments of these aspects are also disclosed in the summary and description below, which provide additional features and advantages.

The first aspect of this disclosure is related to a computer-based method for measurement of a plurality of optical foci,
comprising the steps:
   measuring a first focus;
   obtaining one or both of:
a) a focus range for a measurement of a second focus, wherein the focus range is based on the first focus;
b) a starting value for a measurement of a second focus, wherein the starting value is based on the first focus;
   measuring the second focus with the obtained focus range and/or staring value;
   discarding the second focus, if the second focus is measured as an extreme value of the focus range;
   measuring a third focus.

An optical focus may be comprised of various devices. An optical focus can be a focus system that works with electromagnetic rays, e.g. light rays, UV rays. An optical focus may be encompassed by a medical and/or a diagnostic device, e.g., a microscope. An optical focus may also be comprised by an endoscopy system or an ophthalmoscopy system. Laser systems, e.g., laser surgery systems, may also include an optical focus. An optical focus may also be comprised by a photo camera or a video camera system. An optical focus can be based on a measured image and/or on a measured reflection, e.g. of a laser beam. An optical focus can be measured based on detection of parameters such as contrast, sharpness, phase, light, projected light, wavefronts, pre-known structures, and/or a combination thereof. Additionally or alternatively, an optical focus can be based on parameters such as a focal length, a distance of a sample to the lens, and/or an adjusted lens aperture. A focus can be a point in a depth of field, which is the range of distances in a scene that appear acceptably focused on an image.

A first focus and a second focus are values of an optical focus that are measured at different positions. In case the focus is acquired in z-direction, positions can differ, e.g., in x-direction and/or in y-direction. Foci at different positions, such as a first focus and a second focus, can be acquired within a sample. Additionally or alternatively, foci at different positions can be acquired for different samples. For example, different foci can be acquired from different wells of a multi-well plate. A second focus can be a focus measured after, i.e. later than, a first focus, in particular in a series of foci. A second focus can be in particular a focus consecutive to a first focus.

A focus range can be a range in which a focus is searched. A focus range can be defined as a one-dimensional, in particular linear, space with a maximum value and a minimum value. For example, if contrast is used as the parameter that defines the focus, a focus range can range from a minimum contrast value to a maximum contrast value. If multiple parameters are used for a focus measurement, then a focus range can be defined as a respective multi-dimensional space with a maximum and a minimum for each parameter on which the focus is based. Additionally or alternatively, in case multiple parameters are used, a focus range can be a one-dimensional range that is based on a function/mapping of the respective parameters to this one-dimensional focus range. In case, a second focus is not based on a focus range of a first focus, a pre-defined focus range and/or a technical possible focus range can be used for the second focus.

A starting value for a second focus is a value at which the autofocus system starts to search a focus within a given focus range (e.g. a provided focus range or a technically possible focus range). For a multi-dimensional focus range a starting value can be provided for each dimension of a focus range.

An extreme value can either be a minimum or a maximum of a focus range. Additionally or alternatively, an extreme value can be a value in a pre-defined range or values, e.g. in an upper or lower 5%-band of a focus range. Additionally or alternatively, an extreme value can also be a value that does not lie within the focus range. Such an extreme value can also be termed “outlier”. An outlier can be registered if focal points are measured/calculated that are also outside a pre-defined focus range. In case a plurality of focal points are measured within a same focus range, a second focus can also be subject to statistically analysis. In such a case, an extreme value can be based e.g., on a pre-defined z-score (deviation from a mean) and/or on a pre-defined percentile (e.g. outside a −3σ to +3σ range).

An extreme value can also be content-based. In case a classification is used for finding an object within a focus range. The classified object can mapped to a classification value. For example, an object classified as interesting can be assigned to a value in a first value range and an object classified as non-interesting (e.g. dirt) can be assigned a value in a second value range. In this case, values of the second value range can be determined as extreme values.

Information from a first focus (i.e. a focus range and/or a focus value) can be used for a second focus (as a focus range or as a starting value) after the first focus is checked and declared valid, in particular if it is not measured as an extreme value of its focus range. If a second focus is measured not as an extreme value, it is not discarded. Then it can become a first value for succeeding focus.

Based on a method according to a first aspect malicious foci due to a single wrong focus can be avoided, in particular during an acquisition of a focus map.

Based on a method according to the first aspect a focus map can be derived automatically before an experiment/analysis is started. A focus map can be a representation that indicates the varying levels of focus and/or focus ranges across a sample area. Therefore, based on the method of the first aspect a focus map can be automatically generated by including sample knowledge (cells, tissue etc.) to reliably being able to focus on the right structures during a subsequent experiment.

An embodiment of the first aspect is related to a method for measurement of a plurality of optical foci,
wherein the first focus and the second focus and/or the third focus differ in a well of a multi-well plate.

A multi-well plate, also known as a microplate or microwell plate, can be a flat plate with multiple small wells or compartments arranged in a grid pattern. A multi-well plate can be used in laboratories for conducting a variety of experiments and assays in a high-throughput manner. The wells in the plate can range from a few to several hundred, depending on the specific application and plate size, including 6-well, 12-well, 24-well, 48-well, 96-well, 384-well, and even higher well counts. The wells can be designed to hold samples to be analyzed. Each well can have a position defined by its line and by its column in the multi-well plate.

During a method according to the first aspect, a foci can be obtained for a plurality, in particular for each, well of a multi-well plate. Therefore, the wells can be consecutively processed, i.e. for each well a focus is obtained. The processing can be performed, e.g., line-by-line, column-by-column. Additionally or alternatively, the processing can be performed in a meander pattern (as shown in FIG. 1).

A first, second, and third focus can be obtained after each other. A second focus can be obtained directly after a first focus. Therefore, the well of the second focus can be a well adjacent to a well of a first focus. In a line-by-line or column-by-column processing a second focus can be obtained for a first well of a line/column, if a first focus was acquired for a well at the end of a preceding line/column.

Thereby, focus information of different wells, i.e. of independent samples, can be gathered.

An embodiment of the first aspect is related to a method for measurement of a plurality of optical foci,
wherein the first focus and the second focus and/or the third focus differ in a position perpendicular to a dimension of the focus, within a single sample, in particular within a tissue and/or liquid sample.

As for the previous embodiment, this can involve arranging one or more optical elements, such as lenses or mirrors, in such a way that they can focus on distinct planes within a sample. The positions of the first, second, and/or third focus can be predetermined and in particular evenly spaced from each other. Additionally or alternatively, positions of the different foci can be dependent on one or more of a previous focus.

An embodiment of the first aspect is related to a method for measurement of a plurality of optical foci,
comprising the step:
   identifying one or more pre-defined structures; and
wherein the first, the second and/or the third focus are based on one/or more of the pre-defined structures.

A pre-defined structure can be provided by a data base and/or based on abstract structure information, such has color, height, wavelength, etc. It is possible that different foci can be directed to different pre-defined structures. Furthermore, different structures can be identified based on the assumption that they are located at a similar or even same focal plane. Basing a first, second, or third focus on a pre-defined structure assures that an obtained focus is from an interesting structure and not from, e.g., dirt.

An embodiment of the first aspect is related to a method for measurement of a plurality of optical foci,
comprising the step:
   identifying one or more pre-defined structures; and
wherein a focus range is based on the pre-defined structures.

If an identified structure has a certain height in the dimension of the optical focus, then the upper and lower border of the identified structure can be used as a focus range for a second focus. In this case, the second focus can be searched within the borders of a previously captured structure. Thereby, finding a second focus can be accelerated.

Additionally, if a certain structure is identified, a focus range can be used that is typical for the identified structure. This focus range can then also be used for a second focus. This also could accelerate the acquisition of a second focus.

In another alternative embodiment, information on one or more acceptable pre-defined structures can be provided as an alternative to a focus range or starting value based on the first focus. And a second focus can be discarded if none of the pre-defined structures is found within the searched focus range. For this embodiment, measurement of an extreme focus value is not necessary.

An embodiment of the first aspect is related to a method for measurement of a plurality of optical foci,
wherein one or more of the pre-defined structures is identified based on a classifier, in particular a machine learning algorithm.

A classifier can be any classifier for image classification. A classifier can be based on statistical and/or machine-learning methods.

A classifier can be based on methods void of a training phase such as:
histogram-based methods, e.g., applied to pixel intensity values or color distributions as features;
texture analysis methods configured to analyze texture patterns in images;
shape-based methods configured to detect predefined shapes such as a edges and/or a ratio of bounding box dimensions;
template matching methods configured to search for pre-defined patterns and/or configurations within an image;
scale-invariant feature transform method configured to extract distinctive features from images that are invariant to changes in scale, rotation, and lighting;
component analysis methods that segment an image into connected regions based on pixel values or other image properties;
statistical methods configured to identify statistical measures, such as mean, standard deviation, skewness, and/or kurtosis from image data.
   Non-learning classifiers can be used in scenarios where labeled training data is limited and/or computational efficiency is required.
   A classifier based on machine learning can comprise, e.g., one or more of the following methods:
neuronal networks, in particular convolutional neuronal networks configured to identify certain patterns in an image;
support vector machines, in particular configured to separate different data sets in an obtained image;
random forests;
K-Nearest neighbors methods, e.g. configured to assess a match between a pre-defined image and an obtained image.

Based on neural network a classification and/or pattern identification can be obtained accurately. A neural network can comprise a standard neural network, e.g. VGG and/or ResNET. VGG is a convolutional neural network architecture that can use 3×3 convolutional filters and deep stacking of convolutional layers. ResNET is a deep convolutional neural network architecture that uses residual connections to enable training of very deep neural networks, up to hundreds of layers deep. In particular, a convolutional neural network can be used for efficient image processing. To determine continuous variables for scaling, translation, and rotation of a searched pattern a fully connected single or multilayer regression neural network can be used in addition or alternatively to another classifier. The regression neural network can be a feedforward neural network, such as a multilayer perceptron. The regression neuronal network in particular can be configured to obtain its input from a convolutional neural network. Thereby, a geometric difference can be computed with high accuracy.

An embodiment of the first aspect is related to a method for measurement of a plurality of optical foci, wherein a center of the focus range of the second focus is equal to the first focus.

Centering a focus range for a subsequent focus around the first focus can be an efficient implementation of the assumption that a focus may remain the same or at least similar for different foci. In case a multi-dimensional focus range is used at least one of the dimensions on which a focus is measured may be used for centering a respective dimension of a subsequent focus.

A size of a focus range can depend, e.g., on a prior classification of an image/object detected with a first focus. Additionally or alternatively, a size of a focus range can depend on a previously used size, e.g. it can the size of a focus range used for a first focus. Additionally or alternatively, a size of a focus range can be a pre-defined size, e.g. provided by a human user. In case of a multi-dimensional focus range, different sizes for the individual focus ranges can be determined.

Advantageously, by using information of a first focus, an extrapolation for a discarded second focus can be implemented efficiently.

An embodiment of the first aspect is related to a method for measurement of a plurality of optical foci,
comprising the step:
   adapting the focus range, if the second focus is measured as an extreme value of the focus range and before discarding the second focus.

If a second focus is measured as an extreme value, it might be the case that the focus range was just too small to arrive at an appropriate focus. At least in this case, before a second focus is discarded an extension of the used focus range can make sense. An extension can be of the same size of the used focus range. Additionally or alternatively, an extension can be a fraction of the used focus size, e.g., 10%, 20% or 50%. In case a multi-dimensional focus is used, the extension of the individual foci may differ. Additionally or alternatively, the extension may be dependent on an assessment of how the focus within the used focus range consolidated, i.e. became better. Therefore, a focus range can be based on a gradient of a quality function (focus score function) of the change of the focus or of the change of the focus itself in the used focus range. If within a used focus range a focus consolidated fast but at ended at an extreme value, then a small extension of the used focus range may suffice to arrive at an optimal focus.

Advantageously, by using a focus extension, discarding a second focus too early can be avoided.

An embodiment of the first aspect is related to a method for measurement of a plurality of optical foci,
wherein the focus range is extended on one side of the focus range, in particular on the side of the focus range where the second focus has been identified as an extreme value, or on both sides of the focus range.

Advantageously, by extending a focus range on the side where an extreme value occurred as a second focus, the information that a focus might be in this direction can be used efficiently as it may be unlikely that a second focus will be found on the opposite side. On the other hand, a simple focus extension can be implemented by extending a second focus on both sides, in particular equally.

An embodiment of the first aspect is related to a method for measurement of a plurality of optical foci,
comprising the step:
   extending the focus range for a second time, if the second focus is measured as an extreme value of the extended focus range and the second focus of the extended focus range has a higher focus scoring than the second focus of the non-extended focus range.

In some cases, an extension of a focus range is too small to arrive at a proper second focus (i.e. with an acceptable focus scoring). In this case, a focus value of the second focus can be an extreme value within the extended focus range. If an extreme value is identified for a second time, a further extension of the initial focus range can be beneficial. Therefore, a second focus range extension can be performed before an extreme value is finally discarded. A second focus range extension can be implemented/determined in the same way as a first focus range extension, which was described for the previous embodiment.

The quality of obtained foci can be measured, e.g., based on a focus scoring (function). The higher the scoring, the better the focus. A threshold may indicate when one or more foci are acceptable. A selection between acceptable foci can also be done on the focus scoring. The focus scoring may comprise one or more parameters of the respective focus, such as contrast, sharpness, phase, etc. Additional or alternatively, a focus scoring can be based on a result of a classifier.

However, if a focus is not found within a used focus range and in the first extension of the used focus, there might be the risk that the optical system is consolidating to an undesired focus point, e.g. a stain in a petri dish or a piece of dirt. Therefore, at least when searching a focus within a secondly extended focus range an additional measure may be useful to check the validity of the focus. This can be done e.g. by a classifier (as described above) that classifies the object on which the second focus consolidated (i.e. finally locked-in). If the focused object is not an interesting object, then the second focus can be discarded anyway. Of course, a parallel validity check can also be performed for a focus found within a firstly extended focus or within a non-extended focus.

Advantageously, if information is determined that a second focus may exist than the second focus does not have to be discarded.

An embodiment of the first aspect is related to a method for measurement of a plurality of optical foci,
comprising one or both of the following steps:
   determining the second focus based on a non-discarded focus that precedes the second focus, in particular the first focus; —determining the second focus based on a non-discarded focus that succeeds the second focus, in particular the third focus.

A discarded second focus value can be replaced by an estimated focus, i.e. by an estimated focus value, in different ways.

As a first alternative, an extrapolation can be performed. Such an extrapolation can use knowledge of a focus measurement at another position for an estimation of the second focus. Such a focus can be a preceding focus, e.g., the first focus. In this case, the second focus is replaced by the focus value of the first focus. Furthermore, also the focus range of the first focus can be assigned to the second focus. This can make sense if the focus range is further inherited to foci measured later, e.g., a third focus. In particular a second focus can be estimated based on a mean value of preceding foci. This mean value can be weighted with weights that increase with decreasing distance of the measurement location of the respective focus to the position of the second focus. In this way the nearest focus of the weighted mean value for the second focus has the largest weighting.

An extrapolation can also use information of one or more foci that are measured after the second focus, e.g. for an estimation value of the second focus a third focus can be used. This kind of extrapolation can also be termed ‘backward-extrapolation’ because one or more measured values are used for an extrapolation value for a preceding discarded measurement. (In contrast, the extrapolation described before, which uses one or more measured values for a succeeding discarded measurement, can be called ‘forward extrapolation’.).

As a second alternative, an interpolation can be performed. An interpolation can be based on a forward extrapolation and based on a backward extrapolation. In case of an interpolation one or more measurements before and after a discarded second focus are used for an estimation of the second focus. An interpolation or a backward extrapolation can be in particular used if a focus map, i.e. a map of foci for all positions/wells to be analyzed, is determined and the actual experiment is run afterwards. Of course, a focus map can also be determined by using one or more forward extrapolations for discarded foci.

Advantageously, by using an extrapolation or interpolation, a discarded second focus can be estimated effectively and efficiently.

An embodiment of the first aspect is related to a method for measurement of a plurality of optical foci,
comprising the step:
   determining the second focus based on a non-discarded focus that is measured at a position or well closest to the position of the second focus.

Depending on the way focal points are measured at different positions, a sequence of measurements may result in successive measurements of focal points that are not closest to each other. This can occur, e.g., in case a line-by-line measurement or a column-by-column measurement is used, or if measurements are performed in a random walk. In this case using, if a second focus measurement has been discarded, a preceding first focus might be farer away from the position of the second focus than another focus measured priorly or succeeding. Then it can be decided to use a (non-discarded) focus measurement at a position closer than the position of the preceding first focus. Such a focus can be, e.g., at a pre-defined position directly next to the position of the discarded second focus and/or a well directly next to the well of the discarded second focus. Advantageously, by using information of a focus of a closer position, a discarded second focus can be estimated based on more relevant information.

An embodiment of the first aspect is related to a method for measurement of a plurality of optical foci,
comprising the step:
   obtaining one or more of a starting value or a focus range for a measurement of the third focus, wherein the respective parameter is based on a focus preceding the second focus, in particular the first focus, if the second focus is discarded.

If a second focus is discarded and a focus range and/or a starting value of a third focus is to be based on information of the second focus, then this information has to be provided alternatively. In this case, a basis for the focus range and/or of a starting value of the third focus can be taken from a previous, non-discarded focus.

For example, a focus range can be directly taken from a first focus or at least the center point of the focus range of the third focus can be based on the first focus. Furthermore, a focus range for a third focus can be taken as a (weighted) mean of focus ranges of preceding non-discarded foci. And/or a centerpoint of a focus range of a third focus can be based on a weighted mean of preceding non-discarded foci. Advantageously thereby, a focus range for a third focus can be provided even if a second focus is discarded and no estimation for a second focus (that can be taken e.g. as a center point for the focus range of the third focus) is yet available.

An embodiment of the first aspect is related to a method for measurement of a plurality of optical foci,
comprising the step:
   obtaining one or more of a starting value or a focus range for a measurement of the third focus, wherein the respective parameter is based on a focus succeeding the second focus, if the second focus is discarded.

Similar to the preceding embodiment, information for a third focus can also be provided from information of one or more succeeding foci in case information from a second focus is not available. In an embodiment, the measurement series, e.g. a focus map, can be completed for all available foci and afterwards, the missing foci (i.e. the second foci that were discarded/ignored) can be estimated based on the information of the available foci, in particular of one or more of the nearest foci, and/or of foci with the same classified objects.

Hence, a third focus can be based on forward extrapolation, backward extrapolation, and/or interpolation of one or more existing focus values.

A second aspect of this disclosure is related to computer-based method for measurement of a plurality of optical foci for a focus map,
comprising the steps:
   obtaining a plurality of positions, wherein on each of the positions a focus will be measured;
   measuring a first focus at a first obtained position;
   obtaining one or more requirements for a second focus to be measured at a second position, wherein the requirements comprise at least one of:
a) information of the first focus;
b) information on one or more acceptable objects for the second focus;
   discarding the second focus if the second focus is measured as an extreme value of its focus range and/or if the second focus does not comprise an acceptable object.

The definitions, embodiments and features of the embodiment provided in detail for the first aspect can also hold and/or be used for embodiments of the second (or third) aspect.

A focus map is a map generated for different positions at which an experiment or an analysis should be performed. The experiment or the analysis can be performed concurrently to the generation of the focus map. Additionally or alternatively, the experiment or analysis can be performed after the focus map is completed. Positions of a focus map can be positions of different wells of a multi-well plate or positions within a single sample.

A requirement for a second focus that is based on information of a first focus can be a focus value. A focus value of the first focus can be used as a starting point for a focus search of a second focus. Additionally or alternatively, a requirement for a second focus that is based on information of a first focus can be a focus range. Additionally or alternatively, a requirement for a second focus that is based on information of the first focus can be a classification of an object of the first focus. Additionally or alternatively, a requirement for a second focus can be one or more acceptable objects, e.g. a certain cell organ, which has to be shown in the focus.

The second focus is discarded if a focus value is found to be an extreme value of its focus range and/or if no acceptable object can be found in the second focus. In this case, either no focus was found, or the optical system has only focused on an unwanted object, such as a piece of dirt.

A third aspect of this disclosure is related to a medical device with an autofocus,
configured to:
   execute a method according to one of the preceding claims; or
   communicate with a device, in particular via an application user interface, that executes a method according to one of the preceding claims.

A medical device may also be a laboratory device and/or a diagnostic device. In particular, an application user interface may be arranged for the medical device to exchange information with a central server, e.g., in a cloud. In particular, a method according to the first or second aspect may be operated in the cloud and may in particular cooperate with a plurality of medical devices to adjust their optical foci.

### BRIEF DESCRIPTION OF THE FIGURES

Further advantages and features result from the following embodiments, some of which refer to the figures. The figures do not always show the embodiments to scale. The dimensions of the various features may be enlarged or reduced, in particular for clarity of description. For this purpose the figures are at least partially schematized.

FIG. 1 illustrates a focus map of a multi-well analysis with discarded second foci according to an embodiment of the disclosure.

FIG. 2 illustrates a focus map of a single-sample analysis with discarded second foci according to an embodiment of the disclosure.

FIG. 3 illustrates an extension of a focus range for a second focus according to an embodiment of the disclosure.

FIG. 4 illustrates a classification function related to a second focus according to an embodiment of the disclosure.

FIG. 5 illustrates a further classification function related to a second focus according to an embodiment of the disclosure.

FIG. 6 illustrates a further classification function related to a second focus according to an embodiment of the disclosure.

FIG. 7 illustrates a schematic diagram of a microscope system according to an embodiment of the disclosure.

In the following description reference is made to the accompanying figures which form part of the disclosure, and which illustrate specific aspects in which the present disclosure can be understood. Identical reference signs refer to identical or at least functionally or structurally similar features.

In general, a disclosure of a described method also applies to a corresponding device (or apparatus) for carrying out the method or a corresponding system comprising one or more devices and vice versa. For example, if a specific method step is described, a corresponding device may include a feature to perform the described method step, even if that feature is not explicitly described or represented in the figure. On the other hand, if, for example, a specific device is described on the basis of functional units, a corresponding method may include one or more steps to perform the described functionality, even if such steps are not explicitly described or represented in the figures. Similarly, a system can be provided with corresponding device features or with features to perform a particular method step. The features of the various exemplary aspects and embodiments described above or below may be combined unless expressly stated otherwise.

### DETAILED DESCRIPTION

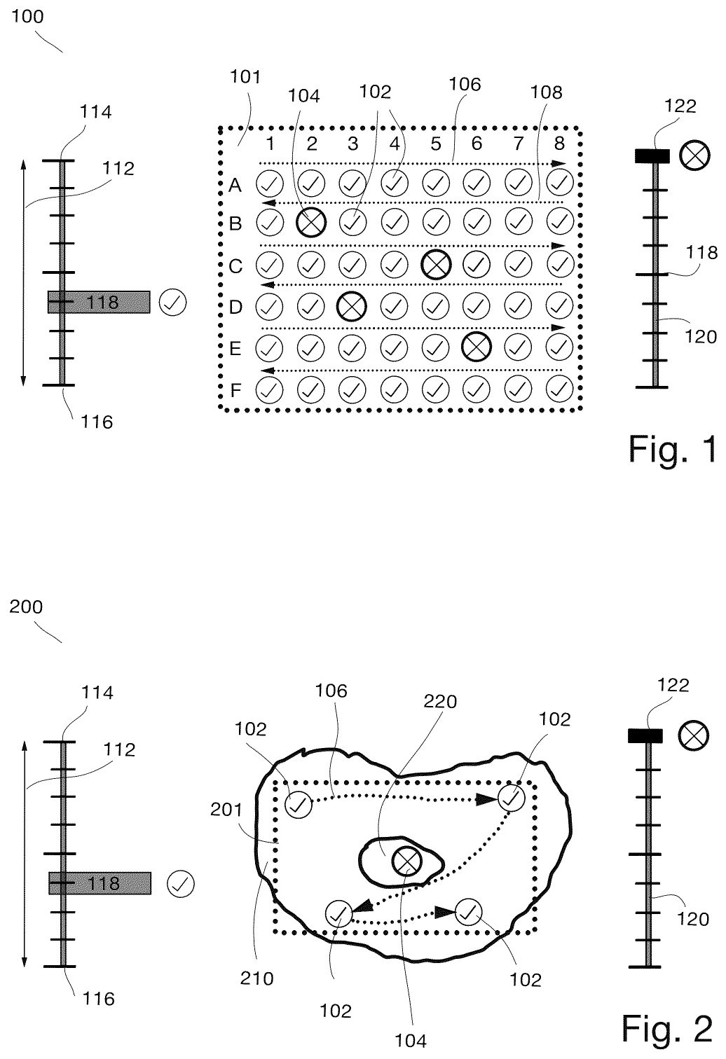

FIG. 1 illustrates a focus map system 100 of a multi-well analysis with discarded second foci according to an embodiment of the disclosure. The goal of the focus map system 100 is to generate a focus map 101 with foci for each well on a multi-well plate. The different wells on the multi-well plate are arranged in columns 1 to 8 and in lines A to F such that each well 102, 104 has a unique position and can be identified by its column and its line. The generation of the focus map is performed sequentially by the optical system, e.g. a microscope (not depicted) that comprises the autofocus that measures each focus. The optical system focusses from above on the multi-well plate 101, i.e. from a dimension perpendicular to the dimensions spawned by the lines A to F and by the columns 1 to 8. In this case the measuring sequence is a meander sequence 106, 108 with one line being sampled in the direction from column 1 to column 8 and the next line being sampled in the other direction from column 8 to column 1. The meander sequence 106, 108 starts at line A and goes down until line F.

In order to use the information of a measured focus efficiently, a focus range of a first focus (which can be principally any focus on the focus map 101) is used for a second focus that succeeds the first focus. Additionally or alternatively the focus value of the first focus is used as a starting value for the second focus. If the focus value of the first focus is used as a starting value for the second focus no focus range of the first focus may be used. The technically possible focus range can be used in this case.

On the left-hand side a scale is depicted showing a focus range 112 of a first focus. The focus has an upper limit 114 and a lower limit 116. In between the focus range 112 the focus is linearly scaled with a center point. The first focus was measured at a focus value (or focus level) 118 that is within the focus range 112. Therefore, the focus is not discarded and assumed valid by the focus map system 100. For example, this could be the focus of the well (3; B) 102 on the focus map 101 or any other focus on the focus map that is indicated with a check mark.

On the right-hand side a scale is depicted showing a focus range of a second focus 120. The focus range of the second focus is equal to the focus range 112 of the first focus. It is inherited from the first focus. Furthermore, the focus value 118 of the first focus is used as centerpoint for the focus range 120 of the second focus. That means the second focus starts its measurement from the focus value measured for the first focus. However, the value 122 for the second focus 120 is measured as an upper limit 114 of the second focus range. Therefore, it is assumed that the measured focus is not consolidated to provide useful information. This could be, e.g., the focus (2; B) 104 on the focus map 101 or any focus on the focus map that is indicated by a cross. The wrong focus measurement could affect the remaining foci. If the focus routine for the next will start with the focus level 122 no focus may be found at all. This failure might continue throughout the rest of the sequence rendering all remaining foci wrong. Therefore, the second focus is discarded. That means the information gained from this focus measurement is ignored.

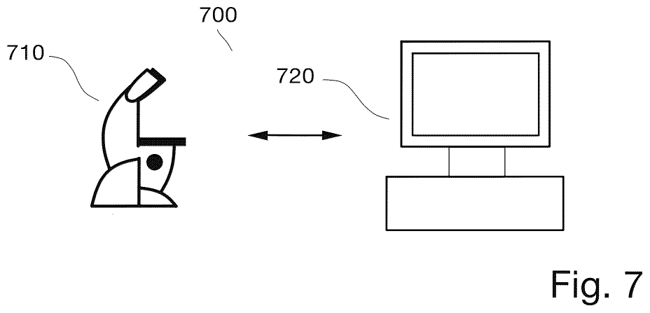

FIG. 2 illustrates a focus map system 200 for a focus map 201 of a single-sample analysis with a discarded second focus according to an embodiment of the disclosure. The focus map is generated with an optical device such as a microscope (e.g. within a microscope system as illustrated in FIG. 7).

An imaged-based autofocus typically searches for high contrast regions but cannot differentiate between a real sample or an unwanted structure such as dust, dirt etc. Therefore, it can happen that the autofocus routine focuses on a wrong structure.

To facilitate an experimental procedure, a focus map, comprising positions and a focus value for each position, can be automatically generated and thereafter (or concurrently) the experiment/analysis can be performed. Focus map positions 102, 104 can be set automatically and the focus level at each position can be generated by using a software autofocus (an image-based autofocus) or a hardware autofocus (a reflection-based autofocus). Thereby, a focus of an already obtained position (“first position”) can be used as starting point for a focus to be measured at another position (“second position”). Additionally or alternatively, a focus range of a first focus (at a first position) can be used as a basis for a focus range of a second focus (at a second position). Additionally or alternatively, if an object was identified for the first focus, this information can also be used to facilitate a finding of a second focus. In this way already available information can be used to facilitate a focus measurement. Based on the focus map an experiment/analysis can be performed. No user interaction is required, and no unnecessary light dosage is applied to the samples.

The single-sample analysis performed in this case is based on the sample 210. The optical system focusses from above on the sample 210, i.e. from a dimension perpendicular to the dimensions of the figure. Within the samples multiple focus positions 102 can be analyzed and a focus (value) 118 can be measured. However, the autofocus does not find a focus if there is no sample, e.g. a hole 220, at the focus map position, e.g. at position 104. In these cases, the autofocus tends to take one of the focus range limits as focus level by mistake. The focus routine at the next focus map position will start with the last found wrong focus level. Since it was the limit of the focus range it will not find a focus and can therefore move further out of focus with every next focus map position. This can make automatic focus map generation unreliable. The user must wait till the focus map is finished and control all the focus points before starting the experiment manually. Otherwise, the wrong focus map points will lead to an imprecise focus map. A similar problem can occur if no acceptable object has been found in a first focus at a certain position. A succeeding second focus cannot be based on an object found for the first focus then.

The definition of a void focus (position) in the embodiment shown here is as follows:

(1) Void focus map positions are positions where the autofocus detects the focus 120 at the limit of the focus range 112 with an upper limit 114 and a lower limit 116. These foci, i.e. focus 104, are then discarded/ignored in the focus map and are interpolated by the adjacent foci. Alternatively, the void focus map positions can be replaced by an automatically created new focus map position in the vicinity following the same procedure.
(2) Void focus positions are positions where a trained classifier to a wanted structure does not “find” this structure in the images of a focus stack. These foci are also discarded/ignored. This can lead to either an additional search above or below the current used focus range.

The embodiment allows the user to reliably generate a focused image and a reliable focus map 201 for a single sample 210. Since the user does not have to control all focus map positions the imaging experiment can be started automatically right after focus map generation. This can save the time the user must dedicate to the experiment/analysis. The described method minimizes wrong focused timepoints thus leading to higher quality data.

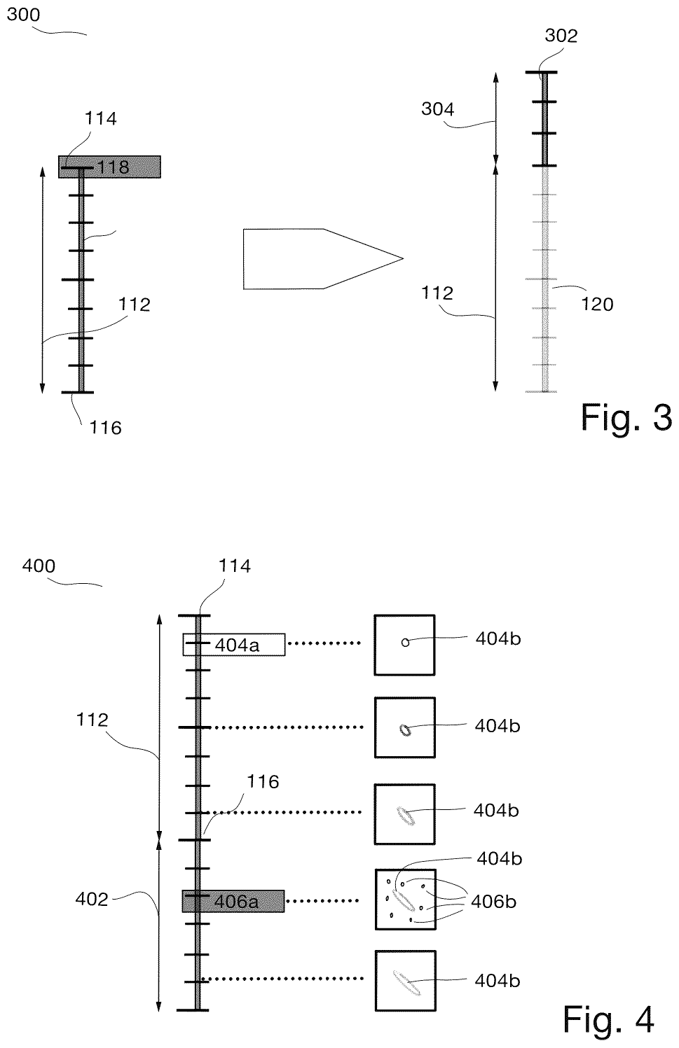

FIG. 3 illustrates an extension function 300 for a second focus according to an embodiment of the disclosure. On the left-hand side a focus of a second focus is depicted with an initial focus range 112. In this embodiment, the focus range 112 is inherited from a first focus previously measured. Alternatively, the focus range 112 can be a standard focus range that is used as initial focus range for all foci of a series of focus measurements. The focus range 112 has an upper limit 114 and a lower limit 116.

As can be seen, the measured second focus (value) 118 equals the upper limit of the focus range 112. This indicates that not a proper focus value for the second focus has been found. However, before the focus value is discarded a further measurement is performed. For this further measurement the focus range 112 is extended. This extended focus range 302 is depicted on the right-hand side. A focus range extension 304 is provided at the side of the focus range 112 where the focus value was measured as limit value 114. Based on the extended focus 300 a second measurement is conducted. If a focus (value) is measured that is not a limit value and/or that depicts a pre-defined agreeable object (such as a specific cell organ) than the secondly measured second focus is validated. Otherwise the second focus is discarded.

FIG. 4 illustrates a classification function 400 related to a second focus according to an embodiment of the disclosure. Thereby, a focus range extension for a second focus is used in combination with an object classification and a focus extension is dependent on a result of the object classification.

A second focus is searched by measurement, i.e. imaging, within an initial focus range 112. The initial focus range has an upper limit 114 and a lower limit 116. Within the initial focus range 112 the optical system can find a first focus value at the focal plane 404a. An object classification is performed concurrently and checks all measured images. The object classification can be based on non-learning and/or machine learning methods (as described above). Based on the object classification it is determined that the object 404b of the firstly found focus value is not an interesting object in the context of the experiment/analysis. This is verified based on the images of the object 404b with other focus values. For example, the object 404b of the first focus value is a piece of dirt. Hence, the focus value is discarded/ignored, and a second focus is not found yet.

However, the focus range 112 is extended on the lower limit 116 by the focus extension 402. A search within the extended focus range yields a further focus value 406a. For the further focus value 406a, the concurrently executed object classification yields a positive result. The objects 406b at this focus value are interesting objects. Hence, the secondly obtained focus value 406a is not discarded/ignored and used as a second focus. (For clarification, the term “second focus” is used as an identifier. The focus can also be termed differently, in particular since the “second focus” does not dependent on a “first focus” in this case.)

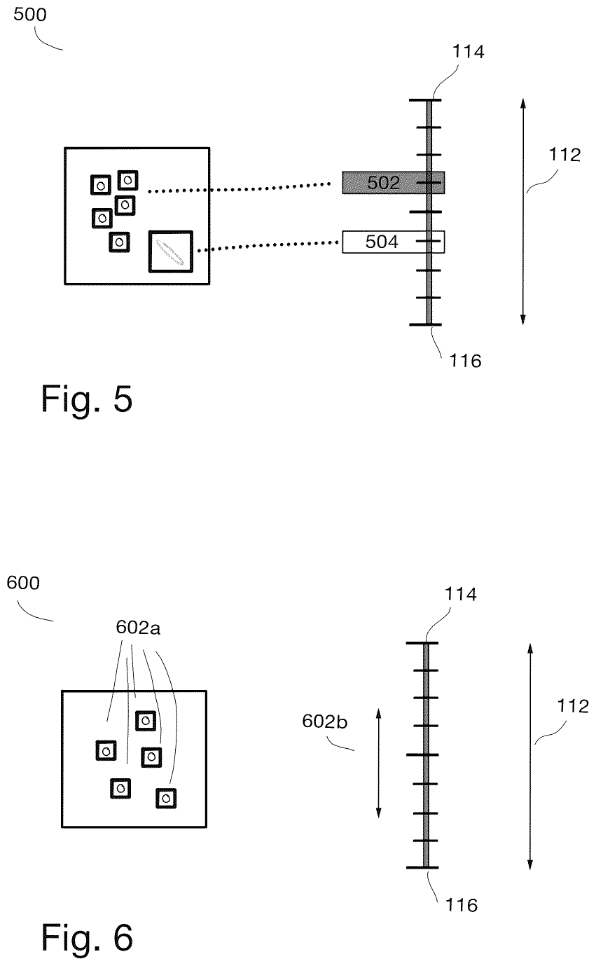

FIG. 5 illustrates a further classification function 500 related to a second focus according to an embodiment of the disclosure. Thereby, a focus measurement for a second focus is used in combination with an object classification and a selection between two focus value candidates is performed dependent on a result of the object classification.

A second focus is searched by measurement within an initial focus range 112. The initial focus range has an upper limit 114 and a lower limit 116. Within the initial focus range 112 the optical system can find a first focus value at the focal plane 502 and a further focus value at the focal plane 504. The latter is even detected as the better focus value. An object classification is performed concurrently and checks the measured foci. Thereby, the object classification determines that the submaximum identified as the firstly found focus has a larger classification score than the maximum identified as the secondly measured focus. Hence, the firstly measured focus is determined as the second focus.

FIG. 6 illustrates a further classification function 600 related to a second focus according to an embodiment of the disclosure. Thereby, a focus measurement for a second focus is used in combination with an object classification and a focus range is dependent on a result of the object classification.

A second focus is searched by measurement within an initial focus range 112. The initial focus range has an upper limit 114 and a lower limit 116. The measurement results in several objects 602a classified as interesting. These objects lie in the focus range 602b. The rest of the focus range 112 does not comprise any interesting objects on which the optical system could focus on. Therefore, the second focus is determined with the focus range 602.

Some embodiments relate to a microscope comprising a system as described in connection with one or more of the FIGS. 1 to 6. Alternatively, a microscope may be part of or connected to a system as described in connection with one or more of the FIGS. 1 to 6.

FIG. 7 shows a schematic illustration of a system 700 configured to perform a method described herein. The system 700 comprises a microscope 710 and a computer system 720. The microscope 710 is configured to take images and is connected to the computer system 720. The computer system 720 is configured to execute at least a part of a method described herein. The computer system 720 may be configured to execute a machine learning algorithm. The computer system 720 and microscope 710 may be separate entities but can also be integrated together in one common housing. The computer system 720 may be part of a central processing system of the microscope 710 and/or the computer system 720 may be part of a subcomponent of the microscope 710, such as a sensor, an actor, a camera, or an illumination unit, etc. of the microscope 710.

The computer system 720 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 720 may comprise any circuit or combination of circuits. In one embodiment, the computer system 720 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system 720 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system 720 may include one or more storage devices, which may include one or more memory elements suitable to the particular application, such as a main memory in the form of random-access memory (RAM), one or more hard drives, and/or one or more drives that handle removable media such as compact disks (CD), flash memory cards, digital video disk (DVD), and the like. The computer system 720 may also include a display device, one or more speakers, and a keyboard and/or controller, which can include a mouse, trackball, touch screen, voice-recognition device, or any other device that permits a system user to input information into and receive information from the computer system 720.

Some or all of the method steps may be executed by (or using) a hardware apparatus, like for example, a processor, a microprocessor, a programmable computer, or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine-readable carrier.

Other embodiments comprise the computer program for performing one of the methods described herein, stored on a machine-readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Embodiments may be based on using a machine-learning model or machine-learning algorithm. Machine learning may refer to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and/or training sequences (e.g. words or sentences) and associated training content information (e.g. labels or annotations), the machine-learning model “learns” to recognize the content of the images, so the content of images that are not included in the training data can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model. The provided data (e.g. sensor data, meta data and/or image data) may be preprocessed to obtain a feature vector, which is used as input to the machine-learning model.

Machine-learning models may be trained using training input data. The examples specified above use a training method called “supervised learning”. In supervised learning, the machine-learning model is trained using a plurality of training samples, wherein each sample may comprise a plurality of input data values, and a plurality of desired output values, i.e. each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm (e.g. a classification algorithm, a regression algorithm or a similarity learning algorithm. Classification algorithms may be used when the outputs are restricted to a limited set of values (categorical variables), i.e. the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine-learning model. In unsupervised learning, (only) input data might be supplied, and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, anomaly detection (i.e. outlier detection) may be used, which is aimed at providing an identification of input values that raise suspicions by differing significantly from the majority of input or training data. In other words, the machine-learning model may at least partially be trained using anomaly detection, and/or the machine-learning algorithm may comprise an anomaly detection component.

In some examples, the machine-learning algorithm may use a decision tree as a predictive model. In other words, the machine-learning model may be based on a decision tree. In a decision tree, observations about an item (e.g. a set of input values) may be represented by the branches of the decision tree, and an output value corresponding to the item may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules are a further technique that may be used in machine-learning algorithms. In other words, the machine-learning model may be based on one or more association rules. Association rules are created by identifying relationships between variables in large amounts of data. The machine-learning algorithm may identify and/or utilize one or more relational rules that represent the knowledge that is derived from the data. The rules may e.g. be used to store, manipulate, or apply the knowledge.

Machine-learning algorithms are usually based on a machine-learning model. In other words, the term “machine-learning algorithm” may denote a set of instructions that may be used to create, train, or use a machine-learning model. The term “machine-learning model” may denote a data structure and/or set of rules that represents the learned knowledge (e.g. based on the training performed by the machine-learning algorithm). In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input.

Alternatively, the machine-learning model may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

List of Reference Signs

| | |
|---|---|
| 100 | focus map system |
| 101 | focus map for multi well table |
| 102 | position with measured focus within limits |
| 104 | position with measured focus at limit |
| 106 | measurement sequence |
| 108 | measurement sequence |
| 112 | first focus range |
| 114 | focus upper limit |
| 116 | focus lower limit |
| 118 | measured focus |
| 120 | second focus |
| 122 | measured focus level |
| 200 | focus map system |
| 201 | focus map for single sample |
| 210 | sample |
| 220 | hole in sample |
| 300 | extension function |
| 302 | extended focus range |
| 304 | focus range extension |
| 400 | classification function |
| 402 | focus extension |
| 404a | firstly measured second focus |
| 404b | unwanted object |
| 406a | secondly measured second focus |
| 406b | interesting object |
| 500 | classification function |
| 502 | firstly measured second focus |
| 504 | secondly measured second focus |
| 600 | classification function |
| 602a | interesting objects |
| 602b | reduced focus range |
| 700 | analysis system |
| 710 | microscope |
| 720 | computer |

1. A computer-based method for measurement of a plurality of optical foci,
comprising the steps:
measuring a first focus;
obtaining one or both of:
a) a focus range for a measurement of a second focus, wherein the focus range is based on the first focus;
b) a starting value for a measurement of a second focus, wherein the starting value is based on the first focus;
measuring the second focus with the obtained focus range and/or staring value;
discarding the second focus, if the second focus is measured as an extreme value of the focus range;
measuring a third focus.

2. The method according to claim 1,
wherein the first focus and the second focus and/or the third focus differ in a well of a multi-well plate.

3. The method according to claim 1,
wherein the first focus and the second focus and/or the third focus differ in a position perpendicular to a dimension of the focus, within a single sample, in particular within a tissue and/or liquid sample.

4. The method according to claim 1,
comprising the step:
identifying one or more pre-defined structures; and
wherein the first, the second and/or the third focus are based on one/or more of the pre-defined structures.

5. The method according to claim 1,
comprising the step:
identifying one or more pre-defined structures; and
wherein a focus range is based on the pre-defined structures.

6. The method according to claim 4,
wherein one or more of the pre-defined structures is identified based on a classifier, in particular a machine learning algorithm.

7. The method according to claim 1,
wherein a center of the focus range of the second focus is equal to the first focus.

8. The method according to claim 1,
comprising the step:
adapting the focus range, if the second focus is measured as an extreme value of the focus range and before discarding the second focus.

9. The method according to claim 8,
wherein the focus range is extended on one side of the focus range, in particular on the side of the focus range where the second focus has been identified as an extreme value, or on both sides of the focus range.

10. The method according to claim 7,
comprising the step:
extending the focus range for a second time, if the second focus is measured as an extreme value of the extended focus range and the second focus of the extended focus range has a higher focus scoring than the second focus of the non-extended focus range.

11. The method according to claim 1,
comprising one or both of the following steps:
determining the second focus based on a non-discarded focus that precedes the second focus, in particular the first focus;
determining the second focus based on a non-discarded focus that succeeds the second focus, in particular the third focus.

12. The method according to claim 11,
comprising the step:
determining the second focus based on a non-discarded focus that is measured at a position or well closest to the position of the second focus.

13. The method according to claim 1,
comprising the step:
obtaining one or more of a starting value or a focus range for a measurement of the third focus, wherein the respective parameter is based on a focus preceding the second focus, in particular the first focus, if the second focus is discarded.

14. The method according to claim 1,
comprising the step:
obtaining one or more of a starting value or a focus range for a measurement of the third focus, wherein the respective parameter is based on a focus succeeding the second focus, if the second focus is discarded.

15. A microscope with autofocus, configured to execute the method according to claim 1.

16. A computer-based method for measurement of a plurality of optical foci for a focus map,
comprising the steps:
obtaining a plurality of positions, wherein on each of the positions a focus will be measured;
measuring a first focus at a first obtained position;
obtaining one or more requirements for a second focus to be measured at a second position, wherein the requirements comprise at least one of:
a) information of the first focus;
b) information on one or more acceptable objects for the second focus;
discarding the second focus if the second focus is measured as an extreme value of its focus range and/or if the second focus does not comprise an acceptable object.

17. A microscope with autofocus, configured to execute the method according to claim 16.
